(19) United States
(12) Patent Application Publication
(10) Pub. No.: US 2024/0193961 A1
(43) Pub. Date: Jun. 13, 2024

(54) PARKING SPACE DETECTION METHOD, ELECTRONIC DEVICE AND COMPUTER-READABLE STORAGE MEDIUM

(71) Applicant: SUTENG INNOVATION TECHNOLOGY CO., LTD., Shenzhen (CN)

(72) Inventor: Ruochan WANG, Shenzhen (CN)

(73) Assignee: SUTENG INNOVATION TECHNOLOGY CO., LTD., Shenzhen (CN)

(21) Appl. No.: 18/525,770

(22) Filed: Nov. 30, 2023

(30) Foreign Application Priority Data
Dec. 7, 2022 (CN) 202211563659.9

(51) Int. Cl. G06V 20/58; G06T 7/13; G06T 7/80; G06V 10/26; G06V 10/44; G06V 10/80; G06V 20/56

(52) U.S. Cl. CPC G06V 20/586; G06T 7/13; G06T 7/80; G06V 10/26; G06V 10/44; G06V 10/80; G06V 20/588; G06T 2207/30264

(57) ABSTRACT

This application provides a parking space detection method, an electronic device, and a computer-readable storage medium. The parking space detection method includes: obtaining a parking space image and parking space lines detected by a radar device at a first position, and an image feature of the parking space image includes an image feature of reference parking space lines; determining an overlapping rate of the parking space lines and the parking space image; determining an included angle of an entrance line in the parking space lines, and determining a target confidence degree of the parking space at the first position based on the overlapping rate and the included angle of the entrance line; and when the target confidence degree is greater than a preset value, determining the parking space at the first position as an available parking space.

### CROSS-REFERENCE TO RELATED APPLICATION

The present application claims the benefit of priority to Chinese Patent Application No. 202211563659.9, filed on Dec. 7, 2022, which is hereby incorporated by reference in its entirety.

### TECHNICAL FIELD

This application pertains to the field of autonomous driving, and in particular, relates to a parking space detection method, an electronic device, and a computer-readable storage medium.

### TECHNICAL BACKGROUND

Autonomous parking means that all available parking spaces around a vehicle are detected by using a camera mounted on the vehicle, then a user selects a parking space in which the user expects to park, and then a parking route is planned based on the parking space in which the user expects to park, which can shorten parking time and improve driving experience of the user.

Detecting the available parking spaces is a key step in the autonomous parking. Existing methods for detecting an available parking space are mainly vision-based parking space detection algorithms. In the vision-based parking space detection algorithms, parking space information is generally determined based on detected parking space lines or detected images including parking space lines. However, the parking spaces are in various shapes and the parking space lines are diverse. Using a single algorithm may cause misidentification or missed identification of the parking spaces, resulting in poor accuracy and stability of the detected parking spaces.

### SUMMARY

In view of this, embodiments of this application provide a parking space detection method, an electronic device, and a computer-readable storage medium, to resolve a problem of poor accuracy and stability of a detected parking space in an existing parking space detection method.

A first aspect of the embodiments of this application provides a parking space detection method, including: obtaining a parking space image and parking space lines detected by a radar device at a first position, where the parking space image is obtained by semantically segmenting an image captured by an image sensor at the first position, and an image feature of the parking space image includes an image feature of reference parking space lines; determining an overlapping rate of the parking space lines and the parking space image;

determining an included angle of an entrance line in the parking space lines, where the included angle of the entrance line is an angle formed by a side adjacent to the entrance line and the entrance line;

determining a target confidence degree of the parking space at the first position based on the overlapping rate and the included angle of the entrance line; and

if the target confidence degree is greater than a preset value, determining the parking space at the first position as an available parking space.

In an embodiment, the parking space lines include first parking space lines detected in a current period and second parking space lines detected in a previous period, where determining a target confidence degree of the parking space at the first position based on the overlapping rate and the included angle of the entrance line includes:
determining a first confidence degree of the first parking space lines based on an overlapping rate corresponding to the first parking space lines and the included angle of the entrance line;
determining a second confidence degree of the second parking space lines based on an overlapping rate corresponding to the second parking space lines and the included angle of the entrance line; and
determining the target confidence degree based on the first confidence degree, position information of the first parking space lines, the second confidence degree, and position information of the second parking space lines.

In an embodiment, before determining a second confidence degree of the second parking space lines based on an overlapping rate corresponding to the second parking space lines and the included angle of the entrance line, the method further includes:
determining a range to which the first confidence degree belongs; and
if the first confidence degree is greater than the first threshold and less than the second threshold, determining the second confidence degree of the second parking space lines based on the overlapping rate corresponding to the second parking space lines and the included angle of the entrance line.

In an embodiment, the method further includes: if the first confidence degree is less than the first threshold, skipping displaying the parking space at the first position on a map.

In an embodiment, determining a target confidence degree of the parking space at the first position based on the overlapping rate and the included angle of the entrance line includes: determining the target confidence degree of the parking space at the first position based on the overlapping rate and the sum of two included angles of the entrance line.

In an embodiment, determining an included angle of an entrance line in the parking space lines includes:
determining a corner point of the entrance line in the parking space lines based on the parking space image; and
determining the included angle of the entrance line based on a position of the corner point.

In an embodiment, the method further includes: calibrating the parking space image by using the parking space lines, to obtain the parking space at the first position.

In an embodiment, the method further includes: if the target confidence degree is greater than a preset value, and a positional relationship between the parking space at the first position and the current vehicle satisfies a preset condition, marking the parking space at the first position as a recommended parking space on a map.

A second aspect of the embodiments of this application provides a parking space detection apparatus, including:
a first calculation module, configured to: obtain a parking space image and parking space lines detected by a radar device at a first position, where the parking space image is obtained by semantically segmenting an image captured by an image sensor at the first position, and an image feature of the parking space image includes an image feature of reference parking space lines; and determine an overlapping rate of the parking space lines and the parking space image;
a second calculation module, configured to: determine an included angle of an entrance line in the parking space lines, where the included angle of the entrance line is an angle formed by a side adjacent to the entrance line and the entrance line; and determine a target confidence degree of the parking space at the first position based on the overlapping rate and the included angle of the entrance line; and an outputting module, configured to: if the target confidence degree is greater than a preset value, determine the parking space at the first position as an available parking space.

A third aspect of the embodiments of this application provides an electronic device, including a memory, a processor and a computer program stored in the memory and capable of running on the processor, where when the processor executes the computer program, the parking space detection method in the first aspect is implemented.

A fourth aspect of the embodiments of this application provides a computer-readable storage medium, where the computer-readable storage medium stores a computer program, and when the computer program is executed by a processor, the parking space detection method in the first aspect is implemented.

A fifth aspect of the embodiments of this application provides a computer program product, where when the computer program product runs on an electronic device, the electronic device performs the parking space detection method in any embodiment of the first aspect.

The parking space lines detected by the radar device at the first position and the parking space image obtained based on the image captured by the image sensor at the first position are obtained, the overlapping rate of the parking space image and the parking space lines is determined, the target confidence degree of the parking space at the first position is determined based on the overlapping rate and the included angle of the entrance line in the parking space lines, and if the target confidence degree is greater than the preset value, the parking space at the first position is determined as the available parking space. Through the foregoing method, the target confidence degree of the parking space at the first position can be determined by combining a detection algorithm of the parking space lines with a detection algorithm of the parking space image. Because the parking space lines can reflect angle information of the parking space and the parking space image can reflect position information of the parking space, determining the target confidence degree of the parking space at the first position by combining the detection algorithm of the parking space lines and the detection algorithm of the parking space line image can improve accuracy of the target confidence degree, thereby improving accuracy and stability of the determined available parking space.

### BRIEF DESCRIPTION OF DRAWINGS

In order to describe technical solutions in embodiments of this application more clearly, the following briefly describes drawings required for description of the embodiments.

FIG. 1 is a schematic flowchart of implementation of a parking space detection method according to an embodiment;

FIG. 2 is a schematic diagram of determining an overlapping rate according to an embodiment;

FIG. 3 is a schematic diagram of determining an overlapping rate according to another embodiment;

FIG. 4 is a schematic diagram of determining a confidence degree corresponding to an included angle between parking space lines according to an embodiment;

FIG. 5 is a schematic diagram of determining a confidence degree corresponding to an included angle between parking space lines according to another embodiment;

FIG. 6 is a schematic diagram of calibrating parking space image according to an embodiment;

FIG. 7 is a schematic diagram of a parking space detection apparatus according to an embodiment; and

FIG. 8 is a schematic structural diagram of an electronic device according to an embodiment.

### DETAILED DESCRIPTION

For the purpose of illustration rather than limitation, the following describes details such as a system structure and technology, to facilitate a thorough understanding of the embodiments of this application. In other cases, detailed descriptions of well-known systems, apparatuses, circuits, and methods are omitted for purpose of brevity while not preventing a person skilled in the art from carrying out the embodiments contained therein.

When used in this specification and appended claims, a term “include” indicates existence of a described feature, integrity, a step, an operation, an element and/or a component, but does not exclude existence or addition of one or more other features, integrity, steps, operations, elements, components and/or a collection thereof.

As used in this specification and the appended claims of this application, unless otherwise the context clearly indicates another case, singular forms of “a,” “an,” and “the” are intended to include plural forms.

The term “and/or” used in this specification and appended claims of this application refers to any combination of one or more of the associated items listed and all possible combinations thereof, and inclusion of these combinations.

In addition, in the description of the present application, the terms such as “first” and “second” are merely intended for purpose of description, and shall not be understood as an indication or implication of relative importance.

Existing parking space detection methods are generally based on a single vision detection algorithm. When a shape of a parking space and a shape of parking space lines change, accuracy and stability of the parking space detected by using the single vision detection algorithm are poor.

Embodiments of this application provide a parking space detection method, where parking space lines detected by a radar device at a first position and a parking space image obtained by photographing the first position by an image sensor are obtained, and an overlapping rate of the parking space lines and the parking space image is determined. A target confidence degree of the parking space at the first position is determined based on the overlapping rate and an included angle of an entrance line in the parking space lines. The target confidence degree reflects a probability that the parking space at the first position is an available parking space, so that the probability that there is the available parking space at the first position can be determined by combining angle information corresponding to the parking space lines and position information corresponding to the parking space image, which improves the accuracy and stability of the determined available parking space.

The parking space detection method provided in this application is exemplarily described below.

The parking space detection method provided in this embodiment of this application is executed on an electronic device. The electronic device may be a device such as a vehicle-mounted terminal, a computer, or a mobile phone.

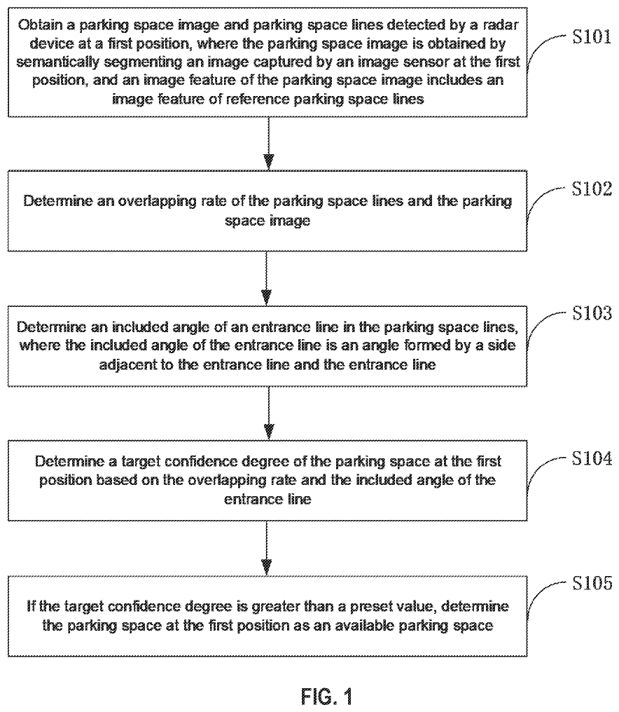

Referring to FIG. 1, the parking space detection method provided in an embodiment of this application includes the following steps.

S101. Obtain a parking space image and parking space lines detected by a radar device at a first position, where the parking space image is obtained by semantically segmenting an image captured by an image sensor at the first position, and an image feature of the parking space image includes an image feature of reference parking space lines.

In some embodiments, a vehicle is mounted with one or more devices such as a camera (for example, a fish-eye camera), the radar device (for example, a LiDAR), Global Positioning System (GPS), and an odometer. During driving of the vehicle, the electronic device can construct a map based on one or more of an image captured by the camera, detection information of the radar device, positioning information of the GPS, and position information recorded by the odometer. After constructing the map, the electronic device can determine a position of the vehicle and positions of objects (for example, another vehicle, parking space, and obstacle) around the vehicle. For example, the electronic device can construct a map with the vehicle as an origin point based on the image captured by the camera and the positioning information. During driving of the vehicle, based on the image captured by the camera, a positional relationship between a target object in the image and the camera is determined, and then based on a positional relationship between the camera and vehicle, coordinates of the target object can be determined, namely, a position of the target object on the map. For another example, after constructing a map with the vehicle as the origin point, the electronic device can determine the position of the target object on the map based on a distance and azimuth information of the target object detected by the radar device, and the positional relationship between the radar device and the vehicle.

The first position is a coordinate range of a current detection region of the vehicle on the map, and the electronic device is configured to determine whether there are parking space lines at the first position based on the detection information of the radar device at the first position.

In an embodiment, the radar device is a LiDAR. The LiDAR receives a detection signal reflected back from the first position and sends the detection signal to the electronic device. Because reflection intensities of the laser beams at corresponding positions of the parking space lines are relatively high, if the electronic device determines that there is a detection signal with a reflection intensity greater than a preset value, the electronic device determines that there are parking space lines at the corresponding positions, and positions corresponding to the detection signal with the reflection intensity greater than the preset value are viewed as the parking space lines. Alternatively, the electronic device may determine that all parking space lines exist in the image captured at the first position, and when determining that the reflection intensity of the detection signal at the corresponding position is greater than the preset value based on the detection information of the radar device, the electronic device may determine that there are parking space lines at the first position, to improve detection accuracy of the parking space lines.

In an embodiment, the electronic device obtains detection signals of the LiDAR at the first position, uses regions corresponding to the detection signals with reflection intensities greater than the preset value as candidate regions, and determines a position of each candidate region. If distance information of the multiple candidate regions is less than the preset value, it is determined that there are parking space lines at the first position.

When determining the candidate regions, a reflection intensity of a detection signal corresponding to each detection point at the first position may be first determined, and the number of detection points with reflection intensities greater than the preset value and positions of the detection points with the reflection intensities greater than the preset value are determined. If the number of detection points with reflection intensities greater than the preset value is greater than a first set value and a distance between the detection points is less than a second set value, then a region formed by each detection point is determined as the candidate region.

In an embodiment, based on the detection information of the radar device, the electronic device can determine that there are corner points of the parking space lines or line segments of the parking space lines at the first position, and the corner points or line segments are connected to obtain the parking space lines. For example, the radar device is the LiDAR, and based on detection signals that are reflected from the first position and received by the LiDAR, the electronic device uses positions corresponding to the detection signals with reflection intensities greater than the preset value as the corner points or line segments of the parking space lines, and connects the corner points or line segments to obtain the parking space lines. The electronic device may alternatively determine that there are the corner points or line segments of the parking space lines in the image captured at the first position, and when determining that the reflection intensity of the detection signal at the corresponding position is greater than the preset value based on the detection information of the radar device, the electronic device may determine that there are the corner points or the line segments at the first position. For example, if, based on the detection information, it is determined that there are two corner points at the first position and a distance between the two corner points is consistent with width of the parking space, the two corner points are connected, and based on a position of a connected line segment and a preset length of the parking space, a rectangle is drawn to obtain the parking space lines. For another example, if it is determined that there are multiple line segments of the parking space lines at the first position based on the detection information, the line segments are connected in sequence based on the preset length and width of the parking space to obtain the parking space lines.

In an embodiment, when the electronic device determines that there are corner points of the parking space lines or line segments of the parking space lines at the first position, the electronic device determines a connection method based on distribution of the corner points or line segments, and connects the corner points or line segments based on the connection method, to obtain the parking space lines, which can improve accuracy of the obtained parking space lines. For example, after determining positions of the corner points or line segments, the electronic device connects adjacent corner points or parking space lines. If two of connected line segments form an angle less than 90° in a parking space, the corner points or line segments are connected based on a preset shape of an inclined parking space, to obtain inclined parking space lines.

In an embodiment, the electronic device obtains the image of the first position captured by the image sensor, extracts an image feature from the image of the first position by using a semantic segmentation algorithm, and segments the image of the first position into the parking space image based on the image feature of the image of the first position, so that the image feature of the parking space image includes an image feature of the preset reference parking space lines. The parking space image is an image of the parking space lines that is obtained by identifying the image of the first position. The parking space image can be a complete image of the parking space lines or a partial image of the parking space lines.

S102. Determine an overlapping rate of the parking space lines and the parking space image.

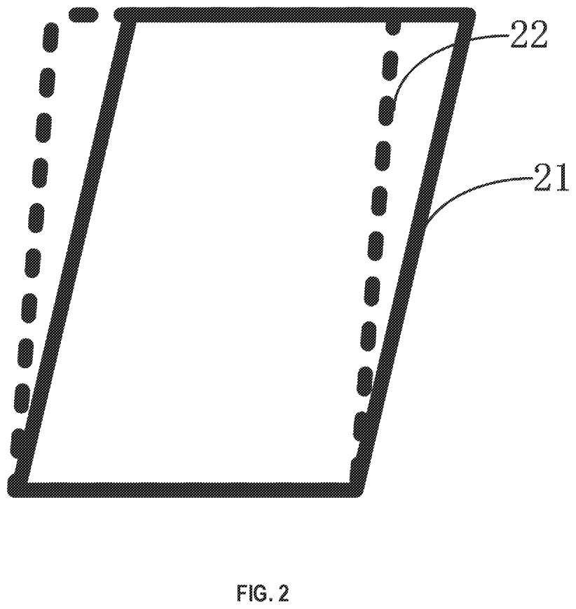

In some embodiments, based on positions of the parking space lines on the map and positions of the parking space lines corresponding to the parking space image on the map, an overlapping rate of the parking space lines and the parking space image can be determined. The overlapping rate of the parking space lines and the parking space image may be an overlapping rate of the parking space lines and the parking space lines corresponding to the parking space image, or an overlapping rate of a region in which the parking space corresponding to the parking space lines is located and a region in which the parking space corresponding to the parking space image is located. For example, as shown in FIG. 2, the parking space lines 21 are the parking space lines detected by the radar device, and the parking space lines 22 are the parking space image. The overlapping rate can be an overlapping rate of the parking space lines 21 and the parking space lines 22, or an overlapping rate of a region encircled by the parking space lines 21 and a region encircled by the parking space lines 22.

If only the target detection algorithm is used to detect the parking space lines at the first position, when the parking space lines do not form a right-angle parking space, some jittering occurs in a detection result of the parking space lines, and complete parking space lines usually cannot be detected during driving of the vehicle. Based on detection results of only some parking space lines, reliability of detected parking space lines cannot be ensured. Because types of line segments of parking space lines and shapes of parking spaces are diverse, if only the image segmentation algorithm is used to determine the parking space lines at the first position, it is impossible to effectively detect all parking spaces. In this embodiment of this application, by determining the overlapping rate of the parking space lines detected at the first position and the parking space line image detected at the first position, two algorithms can be combined to determine reliability of the parking space at the first position from the perspective of both the angle and position of the parking space, thereby improving detection reliability of the parking space.

S103. Determine an included angle of an entrance line in the parking space lines, where the included angle of the entrance line is an angle formed by a side adjacent to the entrance line and the entrance line.

The entrance line in the parking space lines is a side in the parking space lines that is closer to the vehicle. During driving of the vehicle, the image sensor can photograph a complete entrance line in the parking space lines.

In an embodiment, a corner point of the entrance line in the parking space lines is determined based on the parking space image, and an included angle of the entrance line is determined based on a position of the corner point.

In another embodiment, the position of the corner point of the entrance line can also be determined based on the detection information of the radar device, and then the included angle of the entrance line can be determined.

S104. Determine a target confidence degree of the parking space at the first position based on the overlapping rate and the included angle of the entrance line.

In some embodiments, the target confidence degree is determined based on the sum of the confidence degree corresponding to the overlapping rate and the confidence degree corresponding to the angle of the entrance line or based on the weighted sum of the two confidence degrees.

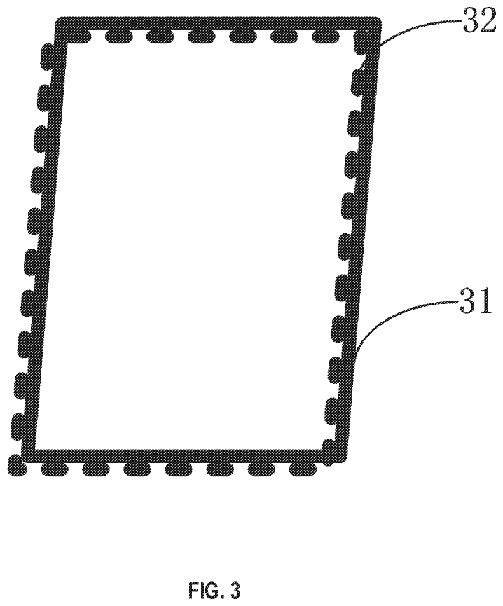

The higher the overlapping rate, the smaller the errors in the angle and position of the parking space at the first position, and the higher the confidence degree corresponding to the overlapping rate. For example, as shown in FIG. 2, the overlapping rate of the parking space lines 21 and the parking space lines 22 is low, and the confidence degree is 0.52. As shown in FIG. 3, parking space lines 31 are the parking space lines detected by the radar device, and parking space lines 32 are the parking space image. An overlapping rate of the parking space lines 31 and the parking space lines 32 is high, and the confidence degree is 0.95.

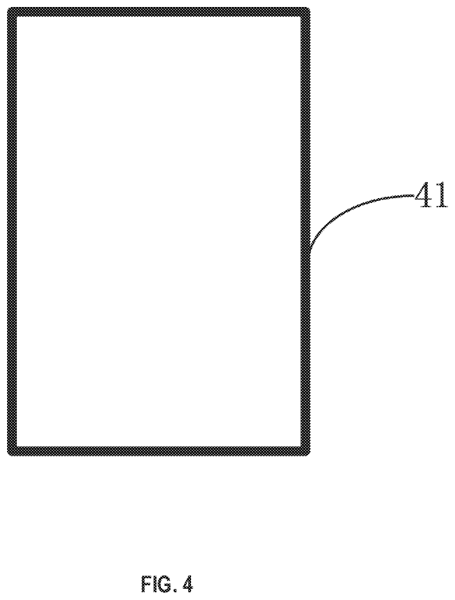

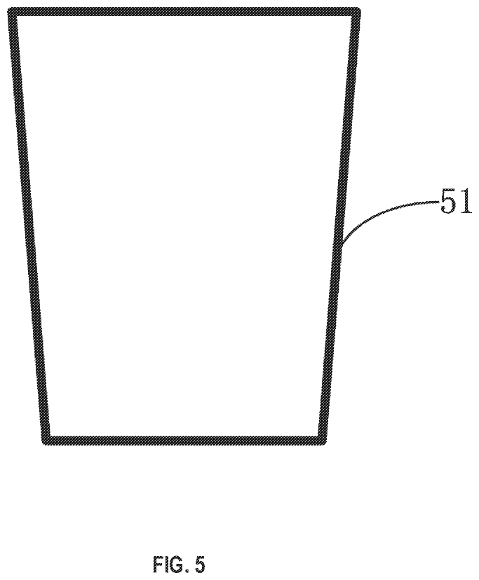

The confidence degree corresponding to the included angle of the entrance line can be determined by a value of an included angle of one entrance line, or can also be determined by the sum of two included angles. Exemplarily, the electronic device can determine the confidence degree corresponding to the included angle of the entrance line based on a difference between one included angle and 90°. The smaller the difference, the higher the confidence degree. The electronic device can also determine the confidence degree corresponding to the included angle of the entrance line based on the difference between the sum of the two included angles and 180°. The smaller the difference, the higher the confidence. Therefore, identification accuracy of the parking space lines is improved. For example, as shown in FIG. 4, the sum of two included angles of entrance line in parking space lines 41 is 180°, and the confidence degree is 0.99. As shown in FIG. 5, the sum of two included angles of entrance line in parking space lines 51 is greater than 180°, the confidence degree is 0.71.

The electronic device can determine the overlapping rate and the included angle of the entrance line in the parking space lines based on the parking space images and parking space lines detected during the same period, and then determine the target confidence degree based on the overlapping rate and the included angle of the entrance line. The electronic device can also obtain the parking space images and parking space lines detected in multiple periods, determine an overlapping rate corresponding to a parking space image and parking space lines detected in each period and an included angle of the entrance line separately, and then determine the target confidence degree based on each overlapping rate and included angle of the entrance line.

Exemplarily, in an embodiment, the parking space lines are the first parking space lines detected in the current period. The electronic device determines an overlapping rate of the first parking space lines detected in the current period and a parking space image detected in the current period, and calculate the sum of the confidence degree corresponding to the overlapping rate and the confidence degree corresponding to the included angle of the entrance line in the first parking space lines, or calculate the weighted sum of the two confidence degrees to obtain the first confidence degree of the first parking space lines and use the first confidence degree as the target confidence degree.

In another embodiment, the parking space lines include first parking space lines detected in a current period and second parking space lines detected in a previous period. After determining the first confidence degree of the first parking space lines, the electronic device determines the second confidence degree of the second parking space lines detected at the first position in the previous period. The second confidence degree can be calculated in the same method as the first confidence degree in the current period, that is, the second confidence degree is determined based on the overlapping rate corresponding to the second parking space lines detected in the previous period and the included angle of the entrance line in the second parking space lines. The second confidence degree may also be the target confidence degree calculated in the previous period. The previous period and the current period can be two adjacent moments, or can be two moments or two frames at intervals of preset duration.

After the first confidence degree and the second confidence degree are determined, the target confidence degree is determined based on the first confidence degree, position information of the first parking space lines, the second confidence degree, and position information of the second parking space lines, so that the probability that there is an available parking space at the first position can be determined with reference to parking space detection situations during two periods, thereby reducing a probability of mistakenly detecting a parking space and improving stability of the detected parking space. The position information of the first parking space lines includes coordinates and an angle of the first parking space lines, and the position information of the second parking space lines includes coordinates and an angle of the second parking space lines. The coordinates refer to coordinates of a center point of the corresponding parking space lines or coordinates of each corner point, and the angles refer to four angles of the corresponding parking space lines. Exemplarily, based on formula Sₜₚ=(Sₜ₋₁*Cₜ₋₁+Sₜ*Cₜ)/(Cₜ₋₁+Cₜ), the target confidence degree of the parking space at the first position is determined. Sₜₚ represents the target confidence degree, Sₜ₋₁ represents the position information of the second parking space lines, Cₜ₋₁ represents the second confidence degree, Sₜ represents the position information of the first parking space lines, and Cₜ represents the first confidence degree.

In an embodiment, after the first confidence degree is determined, a range to which the first confidence degree belongs can be determined first. If the first confidence degree is less than the first threshold, it indicates that there is a large difference between the parking space determined via the target detection algorithm and the parking space determined via the image segmentation algorithm, that is, there are errors in the angle and position of the parking space. A probability of an available parking space at the first position is small, and no subsequent calculation is performed. The parking space at the first position is deleted, and the parking space at the first position is not displayed on the map, which can reduce an amount of subsequent calculations.

If the first confidence degree is greater than the first threshold and less than the second threshold, it is necessary to further determine the confidence degree of the parking space at the first position. In this case, the second parking space lines detected at the first position in the previous period are further obtained. The second confidence degree of the second parking space lines is determined based on the overlapping rate corresponding to the second parking space lines and the angle of the entrance line, and the target confidence degree is determined by combining the first confidence degree and the second confidence degree to improve the accuracy of the detected parking space.

If the first confidence degree is greater than the second threshold, it indicates that the parking space determined via the target detection algorithm and the parking space determined via the semantic segmentation algorithm basically overlap, and the probability of an available parking space at the first position is high. No subsequent calculation is performed, and the parking space at the first position is directly added as the available parking space.

In an embodiment, if it is determined that there are corner points of the parking space lines at the first position based on the detection information of the radar device, the confidence degree of the corner points also needs to be considered when the first confidence degree is calculated, and the confidence degree of the corner points can be determined based on a distance between two adjacent corner points, which can further improve identification accuracy of the parking space. In some embodiments, the electronic device determines that there are at least two corner points at the first position based on the detection information of the radar device, and determines the corner point of the entrance line from the at least two corner points based on distances between the corner points and a position of the current vehicle. For example, if it is determined that there are three corner points at the first position based on the detection information, two corner points closest to the current vehicle are used as corner points of the entrance line. Then the electronic device determines a distance between the two corner points of the entrance line. The smaller the difference between the preset parking space width and the distance between the two corner points, the higher the confidence degree of the corner points.

S105. If the target confidence degree is greater than a preset value, determine the parking space at the first position as an available parking space.

In an embodiment, the preset value may be greater than or equal to the second threshold.

In some embodiments, the electronic device can draw the parking space lines on the map based on the positions of the parking space lines on the map or a corresponding position of the parking space image on the map, or mark the corresponding positions of the parking space lines with a preset color, or add a preset mark at a region in which the parking space lines are located, to indicate that the parking space is the available parking space.

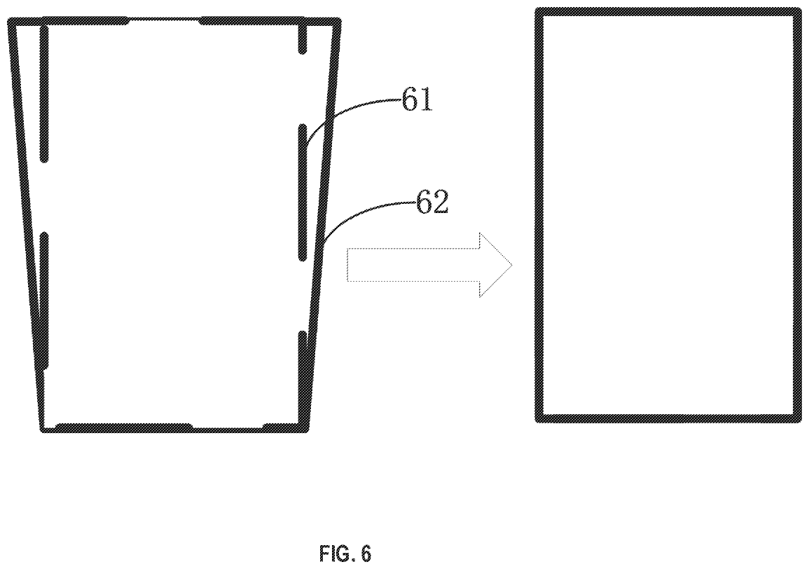

In an embodiment, the electronic device can also calibrate the parking space image by using the parking space lines, and draw the parking space lines at corresponding positions on the map based on the calibrated parking space image to further improve the accuracy of the determined parking space at the first position. For example, as shown in FIG. 6, the parking space lines 61 determined based on the detection information of the radar device do not overlap with the parking space image 62. The parking space lines 61 form a rectangle, and the parking space image 62 is in a shape of a trapezoid. It can be determined that the parking space image 62 is distorted during photographing. The parking space image 62 is calibrated by using the parking space lines 61, and an included angle between adjacent line segments in the calibrated parking space image 62 is a right angle.

During driving of the vehicle, multiple available parking spaces can be determined in the foregoing method provided in this embodiment of this application. The electronic device can mark all available parking spaces, allowing a user to select a parking space in which the user expects to park. The electronic device can also sort the available parking spaces based on a confidence degree corresponding to each available parking space after determining all the available parking spaces. The higher the confidence degree, the higher the recommendation level corresponding to the parking space. Based on sorting results, the user can select a parking space in which the user expects to park. After determining all the available parking spaces, the electronic device can also select and recommend the optimal parking space to the user based on the positions of the available parking spaces.

In an embodiment, if the target confidence degree of the parking space at the first position is greater than a preset value, and a positional relationship between the parking space at the first position and the current vehicle satisfies a preset condition, the parking space at the first position is marked as a recommended parking space on a map. The preset condition is that a distance between the parking space and the current vehicle is the shortest and a planned path between the current vehicle and the parking space is the smoothest. The planned path is a path for the current vehicle to park in the parking space. The electronic device can determine the planned path based on information such as the distance between the current vehicle and the parking space, a direction of the parking space, and a direction of the vehicle. The electronic device can highlight the parking space at the first position on the map to indicate that the parking space at the first position is the recommended parking space.

After determining the recommended parking space, the electronic device can instruct the vehicle to park in the corresponding parking space based on the planned path, thereby saving parking time and improving user experience.

In the foregoing embodiment, an overlapping rate of the parking space lines detected by the radar device at the first position and the parking space image detected by the image sensor at the first position is determined. The target confidence degree of the parking space at the first position is determined based on the overlapping rate and the included angle of the entrance line in the parking space lines, so that the target confidence degree of the parking space at the first position can be determined by combining a detection algorithm of the parking space lines with a detection algorithm of the parking space image. Because the parking space lines can reflect angle information of the parking space and the parking space image can reflect position information of the parking space, determining the target confidence degree of the parking space at the first position by combining the detection algorithm of the parking space lines and the detection algorithm of the parking space line image can improve accuracy of the target confidence degree. Then, when the target confidence degree is greater than the preset value, the parking space at the first position is marked as the available parking space, which improves the accuracy and stability of the determined available parking space.

A sequence number of each step in the foregoing embodiments does not mean an execution sequence. An execution sequence of each process should be determined based on a function and internal logic of each process and shall not limit the implementation process of the embodiments of this application.

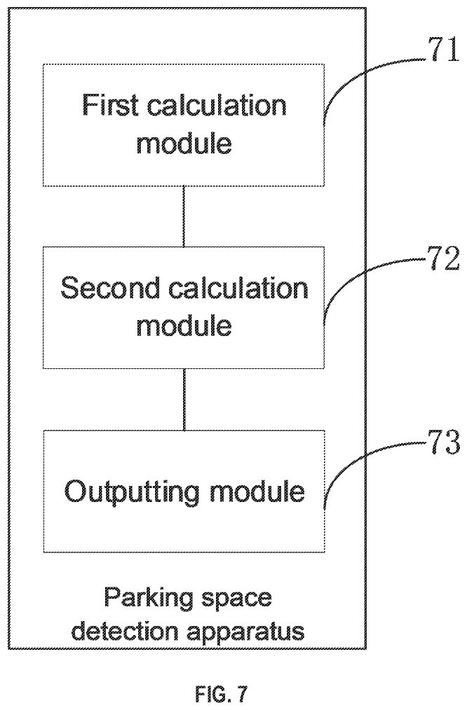

Corresponding to the parking space detection method in the foregoing embodiment, FIG. 7 shows a structural block diagram of a parking space detection apparatus according to an embodiment of this application. For ease of description, only a part related to the embodiments of this application is shown.

As shown in FIG. 7, the parking space detection apparatus includes: a first calculation module 71, configured to: obtain a parking space image and parking space lines detected by a radar device at a first position, where the parking space image is obtained by semantically segmenting an image captured by an image sensor at the first position, and an image feature of the parking space image includes an image feature of reference parking space lines; and determine an overlapping rate of the parking space lines and the parking space image; a second calculation module 72, configured to: determine an included angle of an entrance line in the parking space lines, where the included angle of the entrance line is an angle formed by a side adjacent to the entrance line and the entrance line; and determine a target confidence degree of the parking space at the first position based on the overlapping rate and the included angle of the entrance line; and an outputting module 73, configured to: if the target confidence degree is greater than a preset value, determine the parking space at the first position as an available parking space.

In an embodiment, the parking space lines include first parking space lines detected in a current period and second parking space lines detected in a previous period. The second calculation module 72 is configured to: determine a first confidence degree of the first parking space lines based on an overlapping rate corresponding to the first parking space lines and the included angle of the entrance line; determine a second confidence degree of the second parking space lines based on an overlapping rate corresponding to the second parking space lines and the included angle of the entrance line; and determine the target confidence degree based on the first confidence degree, position information of the first parking space lines, the second confidence degree, and position information of the second parking space lines.

In an embodiment, the second calculation module 72 is further configured to: determine a range to which the first confidence degree belongs; and if the first confidence degree is greater than the first threshold and less than the second threshold, determine the second confidence degree of the second parking space lines based on the overlapping rate corresponding to the second parking space lines and the included angle of the entrance line.

In an embodiment, the outputting module 73 is further configured to: if the first confidence degree is less than the first threshold, skip displaying the parking space at the first position on a map.

In an embodiment, the second calculation module 72 is configured to: determine the target confidence degree of the parking space at the first position based on the overlapping rate and the sum of two included angles of the entrance line.

In an embodiment, the second calculation module 72 is configured to: determine a corner point of the entrance line in the parking space lines based on the parking space image; and determine the included angle of the entrance line based on a position of the corner point.

In an embodiment, the outputting module 73 is further configured to: calibrate the parking space image by using the parking space lines, to obtain the parking space at the first position.

In an embodiment, the outputting module 73 is further configured to: if the target confidence degree is greater than a preset value, and a positional relationship between the parking space at the first position and the current vehicle satisfies a preset condition, mark the parking space at the first position as a recommended parking space on a map.

It should be noted that content such as information exchange and an execution process between the foregoing apparatuses or units is based on the same concept as the method embodiments of this application. For specific functions and technical effects thereof, reference may be made to the method embodiments. Details are not described herein again.

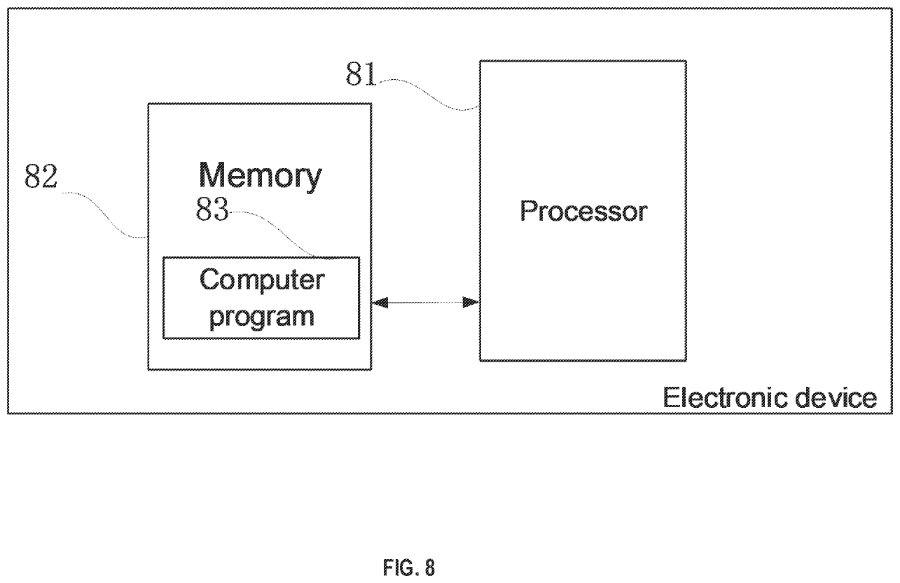

FIG. 8 is a schematic structural diagram of an electronic device according to an embodiment of this application.

As shown in FIG. 8, the electronic device in this embodiment includes: a processor 81, a memory 82, and a computer program 83 stored in the memory 82 and capable of running on the processor 81, where when the processor 81 executes the computer program 83, steps in the embodiments of the parking space detection method are implemented, for example, steps S101 to S105 shown in FIG. 1. Alternatively, when the processor 81 executes the computer program 83, the functions of the modules/units in the foregoing apparatus embodiments are implemented. For example, the functions of the first calculation module 71 to the outputting module 73 shown in FIG. 7.

For example, the computer program 83 may be divided into one or more modules or units, and the one or more modules or units are stored in the memory 82 and are performed by the processor 81 to implement this application. The one or more modules or units may be a series of computer program instruction fields capable of completing specific functions, and the instruction fields are used to describe an execution process of the computer program 83 in the electronic device.

The LiDAR may include more or fewer components than those shown in the figure, or a combination of some components, or different components. For example, the electronic device may also include input and output devices, a network access device, a bus, and the like.

The processor 81 may be a central processing unit (CPU), or may be another general-purpose processor, a digital signal processor (DSP), an application specific integrated circuit (ASIC), a field-programmable gate array (FPGA) or another programmable logic device, a discrete gate or transistor logic device, a discrete hardware component, or the like. The general-purpose processor can be a microprocessor, or the processor can be any conventional processor or the like.

The memory 82 may be an internal storage unit of the electronic device, for example, a hard disk or a memory of the electronic device. The memory 82 may alternatively be an external storage device of the electronic device, for example, a plug-connected hard disk, a smart media card (Smart Media Card, SMC), a secure digital (Secure Digital, SD) card, or a flash card (Flash Card) equipped on the electronic device. Further, the memory 82 may alternatively include both the internal storage unit and the external storage device of the electronic device. The memory 82 is configured to store the computer program and other programs and data required by the electronic device. The memory 82 can also be configured to temporarily store output data or to-be-output data.

In actual application, the foregoing functions can be allocated to different units and modules and implemented according to a requirement, that is, an inner structure of an apparatus is divided into different functional units and modules to implement all or part of the functions described above. The functional units and modules in the embodiments may be integrated into one processing unit, or each unit may exist alone physically, or two or more units may be integrated into one unit. The integrated unit may be implemented in a form of hardware, or may be implemented in a form of a software functional unit. In addition, specific names of the functional units and modules are only for the convenience of distinguishing one another, and are not intended to limit the protection scope of this application. For a detailed working process of units and modules in the foregoing system, reference may be made to a corresponding process in the foregoing method embodiments.

In the foregoing embodiments, the descriptions of the embodiments have respective focuses. For a part that is not described in detail in one embodiment, reference may be made to related descriptions in other embodiments.

In the embodiments provided in this application, the disclosed apparatus or electronic device and method may be implemented in other manners. For example, the embodiments of the described apparatus or electronic device are merely examples. For example, the module or unit division is merely logical function division and may be another division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separated, and parts displayed as units may or may not be physical units, may be located in one position, or may be distributed on a plurality of network elements. Some or all of the units may be selected based on actual requirements to achieve the objectives of the solutions of the embodiments.

When the integrated module or unit is implemented in the form of a software functional unit and sold or used as an independent product, the integrated module or unit may be stored in a computer-readable storage medium. Based on such understanding, some or all of the processes for implementing the methods in the embodiments of this application may be completed by related hardware instructed by a computer program. The computer program may be stored in a computer-readable storage medium. When the computer program is executed by the processor, the steps of the foregoing method embodiments are implemented. The computer program includes computer program code, and the computer program code may be in a form of source code, object code, or an executable file, some intermediate forms, or the like. The computer-readable medium may include: any entity or apparatus capable of carrying the computer program code, a recording medium, a USB flash drive, a removable hard disk, a magnetic disk, an optical disc, a computer memory, a read-only memory (ROM, Read-Only Memory), a random access memory (RAM, Random Access Memory), an electrical carrier signal, a telecommunications signal, a software distribution medium, or the like.

The units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions.

1-9. (canceled)

10. A parking space detection method, comprising:
obtaining a parking space image and parking space lines detected by a radar device at a first position, wherein the parking space lines comprise first parking space lines detected in a current period and second parking space lines detected in a previous period, the parking space image is obtained by semantically segmenting an image captured by an image sensor at the first position, and an image feature of the parking space image comprises an image feature of reference parking space lines;
determining an overlapping rate of the parking space lines and the parking space image, wherein the overlapping rate of the parking space lines and the parking space image is an overlapping rate of a region in which a parking space corresponding to the parking space lines is located and a region in which the parking space corresponding to the parking space image is located;
determining an included angle of an entrance line in the parking space lines, wherein the included angle of the entrance line is an angle formed by a side adjacent to the entrance line and the entrance line;
determining a first confidence degree of the first parking space lines based on an overlapping rate corresponding to the first parking space lines and the included angle of the entrance line; determining a second confidence degree of the second parking space lines based on an overlapping rate corresponding to the second parking space lines and the included angle of the entrance line; and determining a target confidence degree of the parking space at the first position based on the first confidence degree, position information of the first parking space lines, the second confidence degree, and position information of the second parking space lines; and
when the target confidence degree is greater than a preset value, determining the parking space at the first position as an available parking space.

11. The method according to claim 10, wherein before the determining the second confidence degree of the second parking space lines based on the overlapping rate corresponding to the second parking space lines and the included angle of the entrance line, the method further comprises:
determining a range to which the first confidence degree belongs; and
when the first confidence degree is greater than a first threshold and less than a second threshold, determining the second confidence degree of the second parking space lines based on the overlapping rate corresponding to the second parking space lines and the included angle of the entrance line.

12. The method according to claim 11, wherein the method further comprises:
when the first confidence degree is less than the first threshold, skipping displaying the parking space at the first position on a map.

13. The method according to claim 10, wherein the determining the first confidence degree of the first parking space lines based on the overlapping rate corresponding to the first parking space lines and the included angle of the entrance line comprises:
determining the first confidence degree of the first parking space lines based on the overlapping rate corresponding to the first parking space lines and a sum of two included angles of the entrance line.

14. The method according to claim 10, wherein the determining the included angle of the entrance line in the parking space lines comprises:
determining a corner point of the entrance line in the parking space lines based on the parking space image; and
determining the included angle of the entrance line based on a position of the corner point.

15. The method according to claim 10, wherein the method further comprises:
calibrating the parking space image by using the parking space lines, to obtain the parking space at the first position.

16. The method according to claim 10, wherein the method further comprises:
when the target confidence degree is greater than a preset value, and a positional relationship between the parking space at the first position and a current vehicle satisfies a preset condition, marking the parking space at the first position as a recommended parking space on a map.

17. An electronic device, comprising a memory, a processor and a computer program stored in the memory and capable of running on the processor, wherein when the processor executes the computer program, the parking space detection method according to claim 10 is implemented.

18. A non-transitory computer-readable storage medium, wherein the non-transitory computer-readable storage medium stores a computer program, and when the computer program is executed by a processor, the parking space detection method according to claim 10 is implemented.
